(19) United States
(12) Patent Application Publication
(10) Pub. No.: US 2026/0338673 A1
(43) Pub. Date: Oct. 29, 2026

(54) MEASURING SYSTEM

(71) Applicant: Endress+Hauser Conducta GmbH+Co. KG, Gerlingen (DE)

(72) Inventors: Lukas Graf, Mutlangen (DE); Thilo Krätschmer, Gerlingen (DE); Matthias Großmann, Vaihingen-Enz (DE); Hans Meyer, Eschach (DE); Andreas Müller, Ostfildern (DE); Alejandro Vaca Torres, Steinheim (DE)

(21) Appl. No.: 19/660,434

(22) Filed: Apr. 28, 2026

(30) Foreign Application Priority Data
Apr. 28, 2025 (DE) 10 2025 116 216.6

(51) Int. Cl. G01N 21/03; G01N 21/01; G01N 21/15

(52) U.S. Cl. CPC G01N 21/0332; G01N 21/15; G01N 2021/0112; G01N 2021/158; G01N 2201/0231; G01N 2201/0238; G01N 2201/12753

(57) ABSTRACT

A measuring system for optical measurement of at least one measured variable of a medium includes a measuring chamber arranged in a measuring space in a housing and fillable with the medium, a reference module, a protective module and an optical sensor. The reference module includes a reference chamber filled with a reference medium and is insertable into the housing. The protective module includes a protective device for protecting the measuring chamber against condensate formation. The protective device includes a drying agent and is insertable through an opening of the housing into the housing such that the protective module closes the opening and the protective device is arranged in the measuring space. The optical sensor is operable in a measuring mode, in which measurements of the medium are performable, and in a reference mode, in which, reference measurements of the reference medium are performable.

### CROSS-REFERENCE TO RELATED APPLICATION

The present application is related to and claims the priority benefit of foreign patent application No 10 2025 116 216.6, filed on Apr. 28, 2025, the entire contents of which are incorporated herein by reference.

### TECHNICAL FIELD

The present disclosure relates to a measuring system for optical measurement of at least one measured variable of a medium, comprising a housing, in which a measuring space is enclosed, a measuring chamber arranged in the measuring space and fillable with the medium, a reference module, which includes a reference chamber filled with a reference medium and which is insertable, or inserted, into the housing in such a manner that the reference chamber is arranged in the measuring space, and an optical sensor, which is operable in a measuring mode, in which measurements of the medium located in the measuring chamber are performable with the optical sensor, and which, in the case of reference module inserted into the housing, is operable in a reference mode, in which reference measurements of the reference medium located in the reference chamber are performable with the optical sensor.

### BACKGROUND

Measuring systems with optical sensors, such as e.g., turbidity sensors, absorption sensors, fluorescence sensors and/or sensors for measuring a concentration of an analyte contained in a medium, are used in a number of different applications, such as e.g., breweries, clarification systems, laundries as well as plants providing drinking water, for measuring different measured variables of the medium.

Optical sensors comprise a light source, which in measurement operation sends light into the medium, and a detector, which receives measurement radiation resulting from an interaction, such as e.g., absorption, reflection, fluorescence and/or scattering, of the sent light with the medium, and provides a detector signal corresponding to the received measurement radiation. These detector signals are usually made available to an evaluation system, which determines and provides measured values of the measured variable based on the detector signals.

In order with optical sensors to assure a lastingly high accuracy of measurement, the accuracy of measurement of optical sensors is checked in regular intervals. Alternatively or supplementally, a calibrating and/or adjusting of the optical sensor is performed in regular intervals. Both the checking as well as also the calibrating and/or adjusting occurs usually based on reference measurements performed with the sensor on a reference medium. In given cases, reference media are used, which have a limited stability, are health endangering and/or for other reasons can represent a danger for humans and/or the environment. An example of such is the carcinogenic reference medium formazine, which is often used as standard for reference measurements performed with turbidity sensors.

Described in DE 11 2017 005 875 B4 is a system for process-integrated optical analysis of flowable media. Such comprises an optical probe, a flow through cell, through which medium can flow, and a reference unit for performing reference measurements. The system includes a mechanism for bringing about defined positions of the probe relative to the flow through cell and/or the reference unit. Via this mechanism, the probe is selectively bringable into a first relative position, in which measurements with the probe are performable on the medium flowing through the flow through cell, or into a second relative position, in which measurements with the probe are performable on the reference unit. In relative positions, in which the probe adjoins neither the flow through cell nor the reference unit, moreover, measurements are performable on the environmental air.

The system offers the advantage that measurements are performable therewith on a reference medium located in the reference unit, without the medium flowing through the flow through cell being degraded and/or contaminated thereby. At some locations of use, there is, however, the danger that components exposed to the environment, such as e.g., the probe, the flow through cell and/or the reference unit, can get fogged up by moisture condensing thereon. Condensate formation on components, such as e.g., windows, through which optical signals pass during measurements, can result in considerable degradation of the accuracy of measurement achievable with optical sensors. This problem becomes more serious, the more moisture contained in the environmental air, and the greater the temperature of the environmental air compared with the temperature of the component and/or the medium. A high humidity can occur e.g., in poorly ventilated locations of use. Moreover, however, also air movement can continuously bring additional moisture to the vicinity of the components, which then, in given cases, condenses on the components.

This problem can be met e.g., in the manner described in German patent application DE 10 2025 111 958.9 filed 27 Mar. 2025 by applying measuring systems comprising a closed housing, in which a measuring chamber is arranged for receiving the medium and a replaceable reference module, and whose optical sensor is embodied in such a manner that performable therewith are both measurements of the medium located in the measuring chamber as well as also, when required, reference measurements of a reference medium located in a reference chamber of the reference module.

These measuring systems offer the advantage that the measuring chamber, the reference chamber, as well as also the optical sensor are protected by the closed housing against moisture present, in given cases, in the environment of the housing. Disadvantageous, however, is that for each of these measuring systems, especially when a reference module is required lastingly arranged in the housing, reference measurements performed on the reference medium may be only very seldom required. Moreover, reference modules with reference media, whose properties can change with time, must be replaced at regular intervals. Since the housing must be opened for this, there is the danger that, at each replacement, moisture penetrates into the housing, which can then subsequently condense on the measuring chamber. This danger is especially high, when the medium in the measuring chamber has a temperature significantly lower than the environment and/or the replacement is performed at a site of use, such as e.g., a swimming pool or a clarification system, where, in given cases, a high humidity is present.

### SUMMARY

It is an object of the present disclosure to provide a measuring system comprising an optical sensor, with which measurements of a medium, as well as, when required, also reference measurements of a reference medium are performable, which measuring system offers improved protection against condensate formation.

To this end, the present disclosure resides in a measuring system for optical measurement of at least one measured variable of a medium, comprising
a housing, in which a measuring space is enclosed,
a measuring chamber arranged in the measuring space and fillable with the medium,
a reference module, which includes a reference chamber filled with a reference medium and which is insertable, or inserted, into the housing in such a manner that the reference chamber is arranged in the measuring space,
a protective module, which includes a protective device for protecting the measuring chamber against condensate formation and is insertable, or inserted, through an opening of the housing into the housing in such a manner that the protective module closes the opening and the protective device is arranged in the measuring space, wherein the protective device includes a drying agent composed of a moisture adsorbing material, and
an optical sensor, which is operable in a measuring mode, in which, in the case of protective module inserted into the housing, measurements of the medium located in the measuring chamber are performable with the optical sensor, and which is operable in a reference mode, in which, in the case of reference module inserted into the housing, reference measurements of the reference medium located in the reference chamber are performable with the optical sensor.

The measuring system offers the advantage that the protective device of the protective module inserted into the housing absorbs moisture present, in given cases, in the measuring space. In this way, the measuring chamber is protected against condensate formation. This offers the advantage that measurements of the medium are performable with a correspondingly high accuracy of measurement. Other advantages include that both measurements of the medium as well as also reference measurements of the reference medium are performable with the measuring system and the reference module and the protective module are replaceable when required.

Further developments include that
the protective module is formed as a supplemental module insertable, or inserted, into the housing supplementally to the reference module, or
the protective module is formed as a replacement module insertable, or inserted, into the housing in place of the reference module.

A further development provides that the measuring system includes the protective module and a further protective module, wherein the protective module is formed as a supplemental module insertable, or inserted, into the housing supplementally to the reference module, and the further protective module includes a protective device and is formed as a replacement module, which is insertable, or inserted, in place of the reference module, through an opening of the housing into the housing in such a manner that the further protective module closes the opening and the protective device of the further protective module is arranged in the measuring space.

Another development provides that the protective module is formed as a supplemental module insertable, or inserted, supplementally to the reference module, and is insertable, or inserted, into the housing in such a manner that its protective device, in the case of reference module inserted into the housing, is arranged between the measuring chamber and the reference chamber.

Embodiments provide that
the optical sensor is formed and/or usable as an absorption sensor, as a turbidity sensor, as a florescence sensor and/or as a sensor for measuring a concentration of an analyte contained in the medium, and/or
the optical sensor includes at least one light source, by means of which the optical sensor sends light in the measuring mode into the measuring chamber and in the reference mode in the case of reference module inserted into the housing sends light into the reference chamber, and further includes at least one detector, which in the measuring mode receives measurement radiation resulting from an interaction of the light sent into the measuring chamber with the medium and in the reference mode, in the case of reference module inserted into the housing, receives measurement radiation resulting from interaction of the light sent into the reference chamber with the reference medium.

In a first embodiment, the measuring system further comprises a support, wherein
the support includes a first support region, which extends in a hollow space, which, in the case of reference module inserted into the housing, is arranged between the measuring chamber and the reference chamber, and a second support region, which extends outside of the hollow space at least in a direction extending perpendicularly to a longitudinal axis of the first support region,
the support is mounted in the housing rotatably around the longitudinal axis of the first support region, and
the optical sensor includes at least one light source and at least one detector, which are arranged in or on the support in such a manner that in the measuring mode, in which the support is located in a measuring position reachable by a rotation of the support, measurements of the medium located in the measuring chamber are performable with the optical sensor, and in the reference mode, in which the support is located in a reference position reachable by a rotation of the support, in the case of reference module inserted into the housing, reference measurements of the reference medium located in the reference chamber are performable with the optical sensor.

A second embodiment provides that the optical sensor includes a light source and a detector, which are positionable by means of at least one transport device in a measurement position, in which measurements of the medium located in the measuring chamber are performable with the optical sensor, and which are positionable by means of the transport device(s) in a reference position, in which, in the case of reference module inserted into the housing, reference measurements of the reference medium located in the reference chamber are performable with the optical sensor.

Another further development provides that:
the optical sensor and the protective device of the one or at least one protective module are formed in such a manner that, in the case of protective module inserted into the housing, control measurements of the drying agent of the protective device are performable with the optical sensor, and/or
the protective device of the one or at least one protective module includes a reference body of a reference material, a glass or Plexiglass, and this protective device and the optical sensor are formed in such a manner that, in the case of protective module inserted into the housing, control measurements of the reference body are performable with the optical sensor.

Another further development provides that the protective device of the protective module, or of at least one of the protective modules, includes a temperature regulating apparatus formed and/or usable as a cooling device and/or as a heating device for temperature regulation of the protective device.

Other further developments include that the protective device of the one, at least one or each protective module, the measuring chamber and/or the reference chamber is/are equipped with a condensate trap.

Other further developments include that
the reference module is insertable, or inserted, through an opening of the housing into the housing in such a manner that it closes the opening,
the or each protective module is insertable, or inserted, into the housing in such a manner that a longitudinal axis of the protective device of the protective module extends in parallel with a longitudinal axis of the measuring chamber, and/or
the protective module insertable, or inserted, into the housing supplementally to the reference module and/or the protective module insertable, or inserted, into the housing in place of the reference module has dimensions corresponding to dimensions of the reference module.

Furthermore, the present disclosure includes a method for operating a measuring system of the present disclosure, wherein:
in the case of protective module inserted into the housing, at least one measurement of the medium located in the measuring chamber is performed with the optical sensor, and
in the case of reference module inserted into the housing, at least once, recurringly or, when required, at least one reference measurement of the reference medium located in the reference chamber is performed with the optical sensor.

Further developments of the method provide that
a) in the case of protective module inserted into the housing, at least one control measurement of the drying agent is performed with the optical sensor at least once, recurringly or, when required, and/or, based on at least one control measurement performed on the drying agent, a characteristic variable corresponding to an amount of moisture taken up by the drying agent is determined and made available,
b) the protective device of the or at least one protective module includes a reference body made of a reference material, of a glass or Plexiglass and at least once, recurringly or, when required, in the case of protective module inserted into the housing, at least one control measurement of a reference body is performed with the optical sensor,
c) based on reference measurement(s) performed on the reference medium and/or based on control measurement(s) performed on the reference body, a checking of accuracy of measurement, a calibration and/or an adjusting of the optical sensor is performed,
d) based on at least one control measurement performed on the reference body of the protective device of the protective module formed as supplemental module and inserted into the housing, a checking of reference measurement(s) performed on the reference medium located in the reference chamber of the reference module is performed and/or a checking of at least one property of the reference medium is performed, and/or
e) the protective device of the or at least one protective module is, in the case of protective module inserted into the housing, at least once, recurringly or lastingly cooled by means of a temperature regulating device, and/or at least once, recurringly or, when required, outside of the housing heated by means of a temperature regulating device in such a manner that the drying agent expels moisture to the environment.

### BRIEF DESCRIPTION OF THE DRAWINGS

The present disclosure and its advantages will now be explained in greater detail based on the appended drawing, the figures of which show a number of examples of embodiments. Equal elements are provided in the figures with equal reference characters. The figures of the drawing show as follows:

FIG. 1 shows a measuring system including a protective module formed as a supplemental module;

FIG. 2 shows a measuring system including a replaceable reference module;

FIG. 3 shows the measuring system of FIG. 2 having a protective module installed in place of the reference module;

FIG. 4 shows an optical sensor including a support located in a measurement position;

FIG. 5 shows the optical sensor of FIG. 4 with the support in a reference position;

FIG. 6 shows an optical sensor having a transport device; and

FIG. 7 shows a measuring system including a protective module formed as a supplemental module and a reference module replaceable by a further protective module.

### DETAIL DESCRIPTION

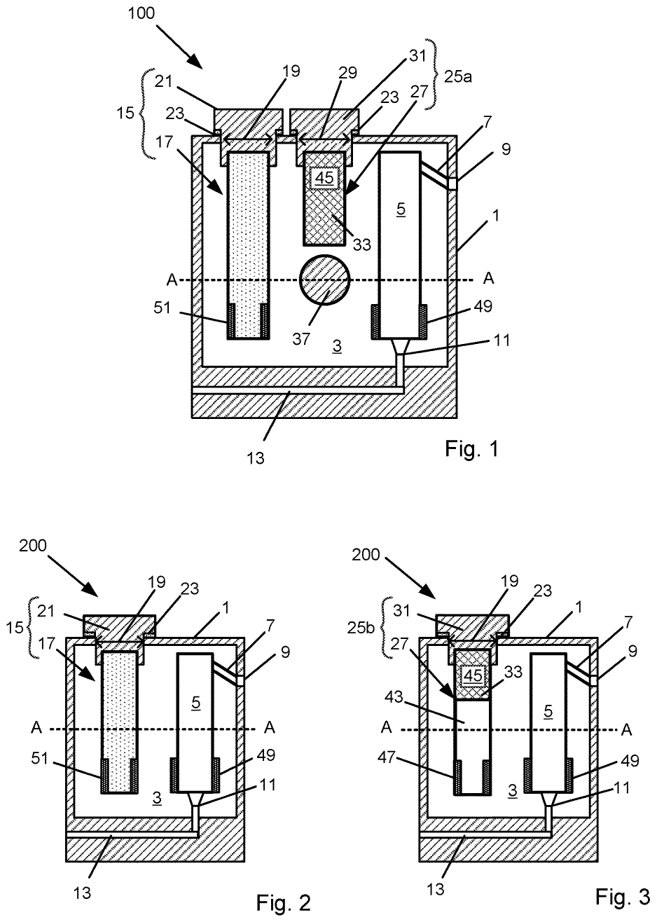

The present disclosure relates to a measuring system 100, 200 for optical measurement of at least one measured variable of a medium. An example of an embodiment is shown in FIG. 1. A further example of an embodiment is shown in FIGS. 2 and 3. The illustrated measuring systems 100, 200 each comprise a housing 1 having a measuring space 3 enclosed in the housing 1 and a measuring chamber 5 arranged in the measuring space 3 and fillable with the medium.

FIGS. 1 to 3 show examples of embodiments, in which the measuring chamber 5 is formed as a component of a flow through measuring cell. The flow through measuring cell includes, opening into the measuring chamber 5, an inlet 7, which is connectable via a first connecting line 9 extending through a housing wall of the housing 1 to a supply line arranged outside of the housing 1 and supplying the medium, and, leaving the measuring chamber 5, an outlet 11, which is connectable via a second connecting line 13 extending through a housing wall of the housing 1 to a drain arranged outside of the housing 1.

Furthermore, each of the illustrated measuring systems 100, 200 includes a reference module 15 having a reference chamber 17 filled with a reference medium. Reference module 15 is insertable, or inserted, into the housing 1 in such a manner that the reference chamber 17 is arranged in the measuring space 3. FIGS. 1 and 2 show the measuring system 100, 200 in a state, in which the reference module 15 is inserted in this way into the housing 1. In the illustrated examples of embodiments, housing 1 includes an opening 19, through which the reference module 7 is insertable, or inserted, into the housing 1 in such a manner that the reference module 15 closes the opening 19. For this, the reference module 15 includes e.g., a closure 21, which closes the opening 19 in the case of reference module 15 inserted into the housing 1 with or without interpositioning of a seal 23.

Each of the illustrated measuring systems 100, 200 includes an optical sensor, which is operable in a measuring mode, in which measurements of the medium located in the measuring chamber 5 are performable with the optical sensor, and which is operable in a reference mode, in which, in the case of reference module 15 inserted into the housing 1, reference measurements of the reference medium located in the reference chamber 17 are performable with the optical sensor.

For this, the optical sensor is formed e.g., in such a manner that it includes at least one light source, by means of which the optical sensor in the measuring mode sends light into the measuring chamber 5 and in the reference mode in the case of reference module 15 inserted into the housing 1 sends light into the reference chamber 17. Furthermore, the optical sensor includes at least one detector, which in the measuring mode receives measurement radiation resulting from an interaction, such as e.g., absorption, reflection, scattering or fluorescence, of the light sent into the measuring chamber 5 with the medium and in the reference mode, in the case of reference module 15 inserted into the housing 1, receives measurement radiation resulting from interaction of the light sent into the reference chamber 17 with the reference medium. In such case, the transmission of the light and/or the measurement radiation occurs in the measuring mode and/or in the reference mode e.g., in each case, directly or via an optical system of the optical sensor.

Depending on embodiment of the optical sensor and/or the number of light sources and/or detectors, the optical sensor is formed and/or usable e.g., as an absorption sensor, as a turbidity sensor, as a florescence sensor and/or as a sensor for measuring a concentration of an analyte contained in the medium. In such case, the, or each light source is formed e.g., to sent light of at least one wavelength, such as e.g., at least one wavelength in the ultraviolet, in the visual and/or in the infrared spectrum. An example of an embodiment for this involves light sources, which comprise one or more light emitting diodes. Moreover, the, or each detector is formed e.g., in such a manner that it determines and provides a detector signal containing at least one property of the received measurement radiation, such as e.g., a radiation intensity, an intensity spectrum and/or at least one spectral intensity value of the received measurement radiation. Examples of embodiments for this are detectors comprising a spectrometer or at least one photodiode.

Furthermore, each of the illustrated measuring systems 100, 200 comprises, insertable, or inserted, into the housing 1, a protective module 25a, 25b, which includes a protective device 27 for protecting the measuring chamber 5 against condensate formation. The protective module 25a, 25b is insertable, or inserted, through an opening 19, 29 of the housing 1 into the housing 1 in such a manner that the protective module 25a, 25b closes the opening 19, 29 and the protective device 27 is arranged in the measuring space 3. FIGS. 1 and 3 show examples of embodiments, in the case of which each of the protective module 25a, 25b includes a closure 31, which, in the case of protective module 25a, 25b inserted into the housing 1, closes the opening 19, 29 with or without interpositioning of a seal 23.

The protective device 27 of the protective module 25a, 25b forms a displacement body, which, upon the insertion of the protective module 25a, 25b into the housing 1, pushes an air volume corresponding to the volume of the protective device 27 out of the measuring space 3. In this way, also moisture contained, in given cases, in this air volume is simultaneously expelled from the measuring space 3. A currently preferred embodiment provides that the protective device 27 comprises a drying agent 33 of a moisture adsorbing material, such as e.g., zeolite or silica gel. Drying agent 33 offers the advantage that, after insertion of the protective module 25a, 25b into the housing 1, it adsorbs moisture, in given cases, still contained in the measuring space 3. In this way, the measuring chamber 5 is protected against condensate formation. In such case, the drying agent 33 is e.g., in the form of a solid piece of material. Alternatively, the drying agent 33 is e.g., in the form of a granular material or gel, which is surrounded by a moisture permeable wall, such as e.g., a wall of silicone or silicone rubber, or a porous carrier, such as e.g., a form retaining latticework.

The freedom of design present as regards the positioning of the protective device 27 in the housing 1 and/or the dimensioning of the protective device 27 can be used in different ways. FIG. 1 shows for this an example of an embodiment, in the case of which the protective module 25a is formed as a supplemental module insertable, or inserted, into the housing 1 supplementally to the reference module 15. This offers the advantage that the protective device 27 of the supplemental module protects the measuring chamber 5 and the reference chamber 17 against condensate formation. In this case, housing 1 includes the opening 19, through which the reference module 15 is insertable, or inserted, into the housing 1, and the opening 29, through which the protective module 25a is insertable, or inserted, into the housing 1.

FIGS. 2 and 3 show an example of an embodiment, in the case of which the protective module 25b is formed as a replacement module insertable into the housing 1 in place of the reference module 15. FIG. 2 shows the measuring system 200 in the case of reference module 15 inserted into the housing 1 and FIG. 3 shows the measuring system 200 in the case of protective module 25b inserted into the housing 1. In such case, the protective module 25b is insertable into the housing 1 through the opening 19, through which alternatively also the reference module 15 can be inserted into the housing 1.

The replaceability of the reference module 15 with the protective module 25b embodied as replacement module offers the advantage that measurements of the medium are also performable with the measuring system 100, 200 without the reference module 15. In such case, the measuring space 3 is closed by the protective module 25b inserted into the housing 1 in place of the reference module 15 and the measuring chamber 5 is protected against condensate formation by the protective module 25b. Another advantage is that a single reference module 15 can be used sequentially in a plurality of measuring systems 100, 200 formed in the above described manner to perform reference measurements of the reference medium. This is advantageous when the reference medium has a low or limited storability.

The protective module 25b shown in FIG. 3, embodied as replacement module, is insertable into the housing 1 analogously also in the measuring system 100 shown in FIG. 1 in place of the reference module 15. In this optional form of embodiment, the measuring system 100 comprises the protective module 25a shown in FIG. 1, embodied as supplemental module, and a further protective module 25b, such as e.g., the protective module 25b shown in FIG. 3, formed as replacement module and insertable, or inserted, into the housing 1 in place of the reference module 15.

The above described measuring systems 100, 200 are operated e.g., in such a manner that the optical sensor in the case of protective module 25a, 25b inserted into the housing 1 is operated at least once in the measuring mode and at least one measurement of the medium located in the measuring chamber 5 is performed with the optical sensor. In each of these measurements, the measuring chamber 5 is protected by the protective device 27 of the protective module 25a, 25b against condensate formation. This offers the advantage that even after, in given cases, required replacement of the reference module 15, as well as in the case of protective module 25b formed as replacement module, even in the absence of the reference module 15, still a high accuracy of measurement is achievable, when the medium is very cold.

Moreover, the optical sensor is, in the case of reference module 15 inserted into the housing 1, operated at least once, recurringly or, when required, in the reference mode and at least one reference measurement of the reference medium located in the reference chamber 17 is performed with the optical sensor. The reference measurement(s) offer the advantage that a checking of the accuracy of measurement, a calibration and/or an adjusting of the optical sensor is performable or performed based on the reference measurement(s). In the checking, it is tested e.g., whether measured values of the measured variable of the reference medium determined with the optical sensor agree within a predetermined error tolerance with reference values predetermined therefor. In the calibration, procedure is e.g., such that, based on at least one measured value of the measured variable of the reference medium determined with the optical sensor and a reference value of the measured variable determined in other manner, at least one reconciliation value is determined, based on which at least one calibration value applied for determining the measured values is checked. In the adjusting, calibration values checked in the context of the calibration are, when required, adapted based on the reconciliation values.

The above described measuring systems 100, 200 as well as the method for their operation have the above mentioned advantages. In at least one embodiment, individual components of the measuring system 100, 200 and/or method steps of method can have embodiments usable individually and/or in combination with one another.

The optical sensor can be formed in different ways. One form of embodiment is that one of the sensors described in German patent application DE 10 2025 111 958.9 filed 27 Mar. 2025 and incorporated here by reference is used as optical sensor. In such case, the optical sensor includes a support 35 having a first support region 37, which in the case of reference module 15 inserted into the housing 1 extends in a hollow space arranged between the measuring chamber 5 and the reference chamber 17, and a second support region 39, which extends outside of the hollow space at least in a direction extending perpendicularly to the longitudinal axis L of the first support region 37. Support 35 is rotatably mounted in the housing 1 about a longitudinal axis L of the first support region 37. Rotation of the support 35 is done manually e.g., by means of a rotary knob 40 connected with the support 35 and/or automatically by means of a motor.

Moreover, the optical sensor includes at least one light source S1, S2 and at least one detector D1, D2, which are arranged in such a manner in or on the support 35 that with the optical sensor in the measuring mode, in which the support 35 is located in a measuring position reachable by a rotation of the support 35, measurements of the medium located in the measuring chamber 5 are performable, and, in the case of reference module 15 inserted into the housing 1, with the optical sensor in the reference mode, in which the support 35 is located in a reference position reachable by a rotation of the support 35, reference measurements of the reference medium located in the reference chamber 17 are performable. For this, the, or each, light source S1, S2 is arranged e.g., in such a manner in or on the support 35 that the, or each, light source S1, S2, in the case of support 35 in the measuring position, sends light into the measuring chamber 5 and, in the case of support 35 in the reference position, sends light into the reference chamber 17. Analogously, each detector D1, D2 is positioned e.g., in such a manner in or on the support 35 that they, in the case of support 35 located in the measuring position, receive measurement radiation, such as e.g., fluorescence, reflection, absorption and/or scattering, resulting from an interaction of light sent from the light source S1, S2, or one of the light sources S1, S2, with the medium, and that they, in the case of support 35 located in the reference position, receive measurement radiation resulting from interaction of the light sent from the light source S1, S2 with the reference medium.

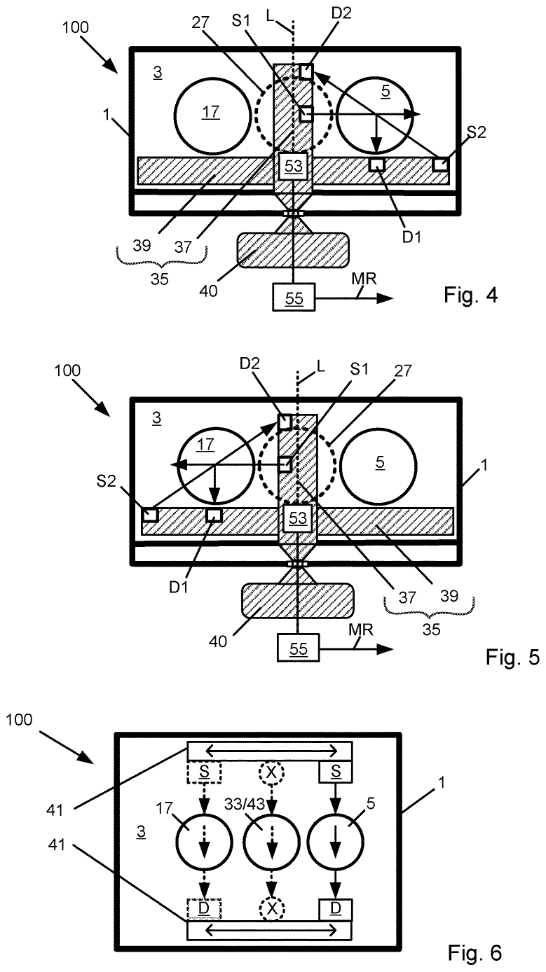

FIGS. 4 and 5 show for this, an example of an embodiment of the measuring system 100 shown in FIG. 1 on cutting plane A-A of FIG. 1 extending through the first support region 37 with an optical sensor formed as just described, in FIG. 4 for the case of support 35 located in the measuring position and in FIG. 5 for the case of support 35 located in the reference position. This optical sensor is formed and/or usable e.g., as a turbidity sensor. For this, at least one detector D1 is arranged in such a manner on the support 35 that it, in the case of support 35 located in the measuring position, receives measurement radiation resulting from a scattering of the light sent from the light source S1 into the medium at a scatter angle determined by the position of the detector D1 and, in the case of support 35 located in the reference position, receives measurement radiation resulting from a scattering of the light sent from the light source S1 into the reference medium at the scatter angle determined by the position of the detector D1.

Alternatively or supplementally, the optical sensor is formed and/or usable e.g., as a florescence sensor. In such case, the sensor includes a light source, by which, in the case of support 35 located in the measuring position, a fluorescing component contained in the medium is excited and, in the case of support 35 located in the reference position, a fluorescing component contained in the reference medium is excited, and a detector, which, in the case of support 35 located in the measuring position, receives fluorescent light emitted by the fluorescing component of the medium and, in the case of support 35 located in the reference position, receives fluorescent light emitted by the fluorescing component of the reference medium. For this, e.g., the measuring arrangement shown in FIGS. 4 and 5 can be used. In such case, the light source S1 is formed as a fluorescence exciting light source and the detector D1 is formed to provide a detector signal corresponding to the fluorescent light received from the detector D1.

Alternatively or supplementally, the optical sensor is formed and/or usable e.g., as an absorption sensor. FIGS. 4 and 5 show an example of an embodiment for this, in the case of which the light source S2 and the detector D2 are arranged on the support 35 in such a manner that an optical signal transmission path extending from the light source S2 to the detector D2, in the case of support 35 located in the measuring position, comprises a transmission path extending through the measuring chamber 5 and, in the case of support 35 located in the reference position, a transmission path extending through the reference chamber 17.

FIG. 6 shows, as another example of an embodiment, an embodiment of the measuring system 100 shown in FIG. 1 in the cutting plane A-A of FIG. 1, in the case of which the optical sensor includes a light source S and a detector D, which, by means of at least one transport device 41, such as e.g., a transport rail, are positionable in a measurement position, in which measurements of the medium located in the measuring chamber 5 are performable with the optical sensor, and which, by means of the transport device(s), 41 are positionable in a reference position, in which, in the case of reference module 15 inserted into the housing 1, reference measurements of the reference medium located in the reference chamber 17 are performable with the optical sensor.

In the illustrated example of an embodiment, the optical sensor is formed and/or usable e.g., as an absorption sensor. For this, the light source S and the detector D are arranged in the measuring position shown in FIG. 6 e.g., in such a manner that the light source S sends light into the measuring chamber 5 and the detector D receives measurement radiation emerging from the measuring chamber 5 on a side of the measuring chamber 5 opposite the light source S. Starting from the measuring position, the light source S and the detector D are shiftable by means of the transport device(s) 41 into the reference position shown dashed in FIG. 6 and vice versa. In the dashed reference position, the light source S and the detector D are arranged in such a manner that the light source S sends light into the reference chamber 17, and the detector D receives measurement radiation from the reference chamber 17 emerging on a side of the reference chamber 17 opposite the light source S.

The optical sensors described based on FIGS. 4 to 6 in connection with the measuring system 100 shown in FIG. 1 are usable analogously also in the measuring system 200 illustrated in FIGS. 2 and 3.

Alternatively or supplementally to the optical sensors, also the protective modules 25a, 25b can have various embodiments. An example of an embodiment shown in FIG. 1 provides that the protective module 25a embodied as a supplemental module is insertable, or inserted, into the housing 1 in such a manner that its protective device 27, in the case of reference module 15 inserted into the housing 1, is arranged between the measuring chamber 5 and the reference chamber 17. That offers the advantage that the protective device 27 provides its greatest protecting effect against condensate formation in the immediate vicinity of the measuring chamber 5 and the reference chamber 17.

Alternatively or supplementally, the, or each protective module 25a, 25b is insertable, or inserted, into the housing 1 e.g., in such a manner that a longitudinal axis of the protective device 27 of the protective module 25a, 25b extends in parallel with a longitudinal axis of the measuring chamber 5.

Independently of the embodiment in this regard, the protective device 27 of the, or each, protective module 25a, 25b has overall dimensions dimensioned, for example, as a function of the space available for it in the measuring space 3. In FIG. 1, the protective device 27 of the protective module 25a formed as supplemental module has in connection with the optical sensor illustrated in FIGS. 4 and 5 a length, which is less than the separation between the opening 29 and the first support region 37. In FIG. 3, the protective module 25b inserted in place of the reference module 15 has dimensions corresponding to the dimensions of the reference module 15. FIG. 8 shows, as further example of an embodiment, a measuring system 300, in the case of which the protective module 25a embodied as a supplemental module has dimensions corresponding to the dimensions of the reference module 15. In such case, the optical sensor is formed e.g., in the manner shown in FIG. 6. Also, this measuring system 300 can comprise supplementally, insertable, or inserted, in place of the reference module 15, another protective module 25b, which has e.g., dimensions corresponding to the dimensions of the reference module 15.

Another optional embodiment provides that the protective device 27 of the protective module 25a, 25b or at least one of the protective modules 25a, 25b of the measuring system 100, 200, 300 and the optical sensor are formed in such a manner that control measurements are performable on the drying agent 33 of the protective device 27.

In the case of this form of embodiment shown by way of example in FIG. 1 and usable analogously in the other measuring systems 200, 300, procedure during operation of the measuring system 100, 200, 300 is e.g., such that at least once, recurringly or, when required, in the case of protective module 25a, 25b inserted into the housing 1, at least one control measurement of the drying agent 33 is performed with the optical sensor. Based on the control measurements, e.g., a characteristic variable is determined and made available, corresponding to an amount of moisture already taken up by the drying agent 33. This offers the advantage that the protective module 25a, 25b or at least the drying agent 33 can be replaced, or is replaced, before the amount of moisture taken up exceeds a limit value predetermined therefor.

Another optional embodiment provides that the protective device 27 of the protective module 25a, 25b or at least one of the protective modules 25a, 25b of the measuring system 100, 200, 300 includes a reference body 43 of a reference material, such as e.g., glass or Plexiglass, and the optical sensor is formed to perform control measurements on the reference body 43.

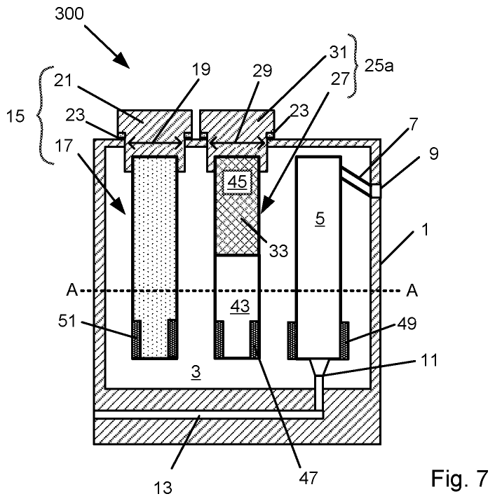

In the case of this form of embodiment illustrated, by way of example, in FIGS. 3 and 7, during operation of the measuring system 200, 300, procedure is e.g., such that at least once, recurringly or, when required, in the case of protective module 25a, 25b inserted into the housing 1, at least one control measurement of the reference body 43 is performed with the optical sensor. These control measurements can be used e.g., in the manner described above in connection with the reference measurements performed on the reference medium. Thus, e.g., procedure is such that, based on the control measurement(s) performed on the reference body 43, a checking of the accuracy of measurement, a calibration and/or an adjusting of the optical sensor is performed. This is advantageous in the case of measuring systems 200 with only one protective module 25b formed as replacement module, where, in the absence of the reference module 15, no reference measurements of the reference medium are performable.

In the case of measuring systems 300 with protective module 25a formed as supplemental module and comprising the reference body 43, alternatively or supplementally thereto, procedure is e.g., such that, based on at least one control measurement performed on the reference body 43 of the protective device 27 of the protective module 25a inserted into the housing 1, a checking of the reference measurement(s) performed on the reference medium located in the reference chamber 17 of the reference module 15 and/or a checking of at least one property of the reference medium is/are performed.

The execution of the control measurement(s) on the drying agent 33 or the reference body 43 of the, in each case, correspondingly formed protective module 25a, 25b can occur in different ways, depending on type of optical sensor. As above described, the optical sensors of the here described measuring systems 100, 200, 300 are operable in the reference mode in such a manner that, in the case of reference module 15 inserted into the housing 1, reference measurements of the reference medium located in the reference chamber 17 are performable with a sensor. This offers, in connection with protective modules 25b formed as replacement module, the advantage that, in the case of protective module 25b inserted into the housing 1 in place of the reference module 15, control measurements of the drying agent 33 correspondingly positioned within the protective device 27 or the reference body 43 of the protective module 25b inserted into the housing 1 and correspondingly positioned within the protective device 27 are performable with the optical sensors in the reference mode.

In connection with the FIGS. 1 and 7 illustrated protective modules 25a insertable into the housing 1 between the reference module 15 and the measuring chamber 5, the optical sensor is e.g., operable in a control mode, in which, in the case of protective module 25a inserted into the housing 1, the above described control measurements are performable with the optical sensor. If one considers, as an example for this, the measuring system 100 shown in FIG. 1 in connection with the optical sensor illustrated in FIGS. 4 and 5, then this optical sensor is operable in a control mode, in which the support 35 is located in an intermediate position reachable by a rotation of the support 35. In the illustrated example of an embodiment, the support 35 is transitioned into the intermediate position starting from the measuring position shown in FIG. 4 by a rotation of 90° around the longitudinal axis L of the first support region 37 and into the reference position shown in FIG. 5 starting from the intermediate position by a further rotation of 90° around the longitudinal axis L. In such case, at least one or each light source S1, S2 is arranged in or on the support 35 e.g., in such a manner that the one or each light source S1, S2, in the case of support 35 located in the intermediate position, sends light in the direction of the drying agent 33 of the protective device 27 of the protective module 25a inserted into the housing 1. Moreover, at least one or each detector D1, D2 is positioned in or on the support 35 e.g., in such a manner that the one or each detector D1, D2, in the case of support 35 located in the intermediate position, receives measurement radiation, such as e.g., fluorescence, reflection, absorption and/or scattering, resulting from an interaction of light sent from the light source S1, S2, or one of the light sources S1, S2, with the drying agent 33.

If one considers the measuring system 300 shown in FIG. 7 as another example therefor in connection with the optical sensor shown in FIG. 6, then this optical sensor is operable in a control mode, in which the light source S and the detector D are located in an intermediate position indicated in FIG. 6 by dash circled X's and reachable by means of the transport device(s) 41, in which intermediate position control measurements of the reference body 43 of the protective device 27 of the protective module 25a inserted into the housing 1 are performable with the optical sensor. Analogously, in the measuring system 300 shown in FIG. 7, e.g., a protective module 25a formed as a supplemental module without reference body can be inserted in place of the protective module 25a illustrated there, and measurements of the drying agent 33 of the protective device 27 of this protective module 25a can be performed with the optical sensor in the control mode.

Independently of whether the measuring system 100, 200, 300 has the protective module 25a formed as supplemental module, and/or the protective module 25b formed as replacement module, the protective module 25a, 25b, or at least one of the protective modules 25a, 25b, is e.g., formed in such a manner that it includes a temperature regulating device 45 for temperature control of the protective device 27. In such case, the temperature regulating device 45 is formed and/or usable e.g., as a cooling device, by means of which the protective device 27 is coolable, and/or formed and/or usable as a heating device, by means of which the protective device 27 is heatable.

Depending on embodiment of the temperature regulating device 45, the measuring system 100, 200, 300 is in the case of protective module 25a, 25b inserted into the housing 1 operated e.g., in such a manner that the protective device 27 is cooled at least once, recurringly or lastingly by means of the temperature regulating device 45. The cooling increases the probability that the dew point in the housing 1 at the protective device 27 located in the measuring space 3 is subceeded. That offers the advantage that the cooled protective device 27 takes in more moisture from the measuring space 3 by adsorption and/or condensation.

Alternatively or supplementally, the measuring system 100, 200, 300 is operated e.g., at least once, recurringly, or when required, in such a manner that the protective device 27 is heated before insertion of the protective module 25a, 25b into the housing 1 and/or after removal of the protective module 25a, 25b from the housing 1 by means of temperature regulating device 45 in such a manner that the drying agent 33 gives off moisture to the environment. The heating of the protective device 27 outside of the housing 1 offers the advantage that the protective device 27 is then able to take in more moisture after reinsertion into housing 1.

Alternatively, however, procedure can also be that the protective module 25a, 25b or at least the therein contained drying agent 33 is replaced at least once, recurringly or, when required. This procedure is advantageous when the protective module 25a, 25b has no temperature regulating device 45 or the temperature regulating device 45 is formed purely as a cooling device.

Another optional embodiment provides that the protective device 27 of the protective module 25a, 25b, or the protective device 27 of at least one or each of the protective modules 25a, 25b comprises a condensate trap 47. In such case of forms of embodiment, in which control measurements of the drying agent 33 or the reference body 43 of the protective device 27 are performable, the condensate trap 47 is, for example, placed on a section of the protective device 27, which lies outside of a measurement section of the protective device 27, where control measurements are performable with the optical sensor. FIGS. 3 and 7 show, in this connection, an example of an embodiment, in which the condensate trap 47 is placed at a section of the reference body 43, which lies outside of the measuring section, in which control measurements are performable on the reference body 43.

Alternatively or supplementally, also the measuring chamber 5 and/or the reference chamber 17 can be equipped with a condensate trap 49, 51. FIGS. 1 to 3 and FIG. 7 show for this, an example of an embodiment, in the case of which the condensate trap 49 of the measuring chamber 5 is placed on a section of the measuring chamber 5, which lies outside of a measurement section of the measuring chamber 5, where measurements of the medium are performable with the optical sensor. FIGS. 1, 2 and 7 show an example of an embodiment, in which the condensate trap 51 of the reference chamber 17 is placed at a section of the reference chamber 17, which lies outside of a measurement section of the reference chamber 17, where reference measurements of the reference medium are performable with the optical sensor.

The condensate traps 47, 49, 51 of the protective device 27, the measuring chamber 5 and/or the reference chamber 17 are composed e.g., of a material, such as e.g., a metal, which has a high thermal conductivity favoring condensate formation. In such case, the, or each, condensate trap 47, 49, 51 is formed e.g., as a jacket surrounding the pertinent section or as a coating placed externally on the section.

Each condensate trap 47, 49, 51 offers the advantage that residual moisture contained, in given cases, in the measuring space 3 condenses mainly on the condensate trap 47, 49, 51. In this way, the measuring segments of the measuring chamber 5, the reference chamber 7, as well as, in given cases, also the reference body 43 are protected against condensate formation. That offers the advantage that a higher accuracy of measurement is achievable with the optical sensor.

With reference to the performing of the measurements, the reference measurements, as well as, in given cases, also the control measurements, the measuring apparatus 100, 200, 300 is e.g., formed in such a manner that it includes an electronics 53, via which the optical sensor is supplied with energy. The electronics 53 further includes a control unit for controlling the measurements performed with the optical sensor and/or for operating the light source(s) S, S1, S2, and/or providing the detector signals to an evaluation system 55. FIGS. 4 and 5 show, for this, an example of an embodiment, in which the electronics 53 is arranged in the housing 1, e.g., in or on the support 35, and is connected or connectable via a connection line led out from the housing 1 to the evaluation system 55. Independently of the position of the electronics 53, the evaluation system 55, embodied as a component of the measuring apparatus 100, 200, 300 or connectable or connected to the measuring apparatus 100, 200, 300, is formed e.g., to determine and provide measurement results MR based on the detector signals. These measurements results MR comprise, e.g., based on the measurement results of the measured variable(s) of the medium determined in the measuring mode with the optical sensor performed measurements, based on the measurement results of at least one property of the reference medium determined in the reference mode with the optical sensor performed reference measurements, as well as, in given cases, also based on the measurement results of at least one property of the drying agent 33 or the reference body 43 determined in the reference mode or in the control mode with the optical sensor performed control measurements.

1. A measuring system for optical measurement of at least one measured variable of a medium, comprising
a housing, in which a measuring space is enclosed,
a measuring chamber arranged in the measuring space and fillable with the medium,
a reference module, which includes a reference chamber filled with a reference medium and is insertable, or inserted, into the housing in such that the reference chamber is arranged in the measuring space,
a protective module, which includes a protective device for protecting the measuring chamber against condensate formation and is insertable, or inserted, through an opening of the housing into the housing such that the protective module closes the opening and the protective device is arranged in the measuring space, wherein the protective device includes a drying agent of a moisture adsorbing material, and
an optical sensor, which is operable in a measuring mode, in which, when the protective module inserted into the housing, measurements of the medium located in the measuring chamber are performable with the optical sensor, and which is operable in a reference mode, in which, in the case of reference module inserted into the housing, reference measurements of the reference medium located in the reference chamber are performable with the optical sensor.

2. The measuring system as claimed in claim 1, wherein
the protective module is formed as a supplemental module insertable, or inserted, into the housing supplementally to the reference module, or
the protective module is formed as a replacement module insertable, or inserted, into the housing in place of the reference module.

3. The measuring system as claimed in claim 1, which includes the protective module and further comprises a further protective module, wherein the protective module is formed as a supplemental module insertable, or inserted, into the housing supplementally to the reference module, and the further protective module includes a protective device and is formed as a replacement module, which is insertable, or inserted, into the housing in place of the reference module, through an opening of the housing such that the further protective module closes the opening and the protective device of the further protective module is arranged in the measuring space.

4. The measuring system as claimed in claim 1, wherein the protective module is formed as a supplemental module insertable, or inserted, supplementally to the reference module, and is insertable, or inserted, into the housing such that its protective device, when the reference module is inserted into the housing, is arranged between the measuring chamber and the reference chamber.

5. The measuring system as claimed in claim 1, wherein
the optical sensor is formed and/or usable as an absorption sensor, as a turbidity sensor, as a florescence sensor and/or as a sensor for measuring a concentration of an analyte contained in the medium, and/or
the optical sensor includes at least one light source, by means of which the optical sensor sends light into the measuring chamber in the measuring mode and, in when the reference module is inserted into the housing, sends light into the reference chamber in the reference mode, and further includes at least one detector, which in the measuring mode receives measurement radiation resulting from an interaction of the light sent into the measuring chamber with the medium and in the reference mode, in the case of reference module inserted into the housing, receives measurement radiation resulting from interaction of the light sent into the reference chamber with the reference medium.

6. The measuring system as claimed in claim 1, further comprising a support, wherein
the support includes a first support region, which extends in a hollow space, which, when the reference module is inserted into the housing, is arranged between the measuring chamber and the reference chamber, and a second support region, which extends outside of the hollow space at least in a direction extending perpendicularly to a longitudinal axis of the first support region,
the support is mounted in the housing rotatably around the longitudinal axis of the first support region, and
the optical sensor includes at least one light source and at least one detector, which are arranged in or on the support such that in the measuring mode, in which the support is located in a measuring position reachable by a rotation of the support, measurements of the medium located in the measuring chamber are performable with the optical sensor, and in the reference mode, in which the support is located in a reference position reachable by a rotation of the support, when the reference module is inserted into the housing, reference measurements of the reference medium located in the reference chamber are performable with the optical sensor.

7. The measuring system as claimed in claim 1, wherein the optical sensor includes a light source and a detector, which are positionable by means of at least one transport device in a measurement position, in which measurements of the medium located in the measuring chamber are performable with the optical sensor, and which are positionable by means of the transport device(s) in a reference position, in which, when the reference module is inserted into the housing, reference measurements of the reference medium located in the reference chamber are performable with the optical sensor.

8. The measuring system as claimed in claim 1, wherein:
the optical sensor and the protective device of the or at least one protective module are formed such that, when the protective module is inserted into the housing, control measurements of the drying agent of the protective device are performable with the optical sensor, and/or
the protective device of the one or at least one protective module includes a reference body of a reference material, a glass or Plexiglass, and this protective device and the optical sensor are formed such that, when the protective module is inserted into the housing, control measurements of the reference body are performable with the optical sensor.

9. The measuring system as claimed in claim 1, wherein the protective device of the protective module, or of at least one of the protective modules, includes a temperature regulating apparatus formed and/or usable as a cooling device and/or as a heating device for temperature regulation of the protective device.

10. The measuring system as claimed in claim 1, wherein the protective device of the one, at least one or each protective module, the measuring chamber and/or the reference chamber is/are equipped with a condensate trap.

11. The measuring system as claimed in claim 1, wherein
the reference module is insertable, or inserted, through the opening of the housing into the housing such that it closes the opening,
the or each protective module is insertable, or inserted, into the housing such that a longitudinal axis of the protective device of the protective module extends in parallel with a longitudinal axis of the measuring chamber, and/or
the protective module insertable, or inserted, into the housing supplementally to the reference module and/or the protective module insertable, or inserted, into the housing in place of the reference module has dimensions corresponding to dimensions of the reference module.

12. A method for operating the measuring system as claimed in claim 1, wherein:
when the protective module is inserted into the housing, at least one measurement of the medium located in the measuring chamber is performed with the optical sensor, and
in the case of reference module inserted into the housing, at least once, recurringly or, when required, at least one reference measurement of the reference medium located in the reference chamber is performed with the optical sensor.

13. A method for operating the measuring system as claimed in claim 12, wherein
a) in the case of protective module inserted into the housing, at least one control measurement of the drying agent is performed with the optical sensor at least once, recurringly or, when required, and/or, based on at least one control measurement performed on the drying agent, a characteristic variable corresponding to an amount of moisture taken up by the drying agent is determined and made available,
b) the protective device of the or at least one protective module includes a reference body made of a reference material, of a glass or Plexiglass and at least once, recurringly or, when required, in the case of protective module inserted into the housing, at least one control measurement of a reference body is performed with the optical sensor,
c) based on the reference measurement(s) performed on the reference medium and/or based on the control measurement(s) performed on the reference body, a checking of accuracy of measurement, a calibration and/or an adjusting of the optical sensor is performed,
d) based on at least one control measurement performed on the reference body of the protective device of the protective module formed as supplemental module and inserted into the housing, a checking of reference measurement(s) performed on the reference medium located in the reference chamber of the reference module is performed and/or a checking of at least one property of the reference medium is performed, and/or
e) the protective device of the or at least one protective module is, in the case of protective module inserted into the housing, at least once, recurringly or lastingly cooled by means of a temperature regulating device, and/or at least once, recurringly or, when required, outside of the housing heated by means of a temperature regulating device such that the drying agent expels moisture to the environment.
